(19) United States
(12) Patent Application Publication
(10) Pub. No.: US 2018/0230958 A1
(43) Pub. Date: Aug. 16, 2018

(54) SYSTEM AND METHOD FOR REPOSITIONING A HEAT ENGINE ROTOR

(71) Applicant: Valeo Equipements Electriques Moteur, Creteil (FR)

(72) Inventors: Didier Canitrot, Creteil (FR); Ahmed Bchaier, Creteil (FR); Baptiste Guillerm, Creteil (FR)

(73) Assignee: Valeo Equipements Electriques Moteur, Creteil (FR)

(21) Appl. No.: 15/895,331

(22) Filed: Feb. 13, 2018

(30) Foreign Application Priority Data
Feb. 13, 2017 (FR) 1751168

(51) Int. Cl. F02N 19/00; F02N 11/00; F02N 15/00

(52) U.S. Cl. CPC F02N 19/005; F02N 11/00; F02N 15/003; F02N 2019/008; F02N 2300/104; F02N 2200/022; F02N 2300/30; F02N 2200/042; F02N 2200/021

(57) ABSTRACT

The invention relates to a method for rotational positioning of a heat engine rotor (3) that is in a stopped position (θ_{A}) to a target position (θ₀), comprising the following steps:
a device for detecting the angular position of the rotor (3) determines an angular difference (Δθ) from the target position (θ₀),
a speed set-point (Ω_{c}(θ)) as a function of the angular position (θ) of the rotor (3) is established from the angular difference (Δθ), with a rising slope less than a predetermined value (a) followed until a high speed value is reached less than a predetermined value (Ω₀), and a falling slope less than a predetermined value (b),
the rotor (3) is set in motion following the speed set-point (Ω_{c}(θ)).

The present invention relates to a system for repositioning a rotor of a combustion engine, for example of a motor vehicle, as well as the associated method.

For reducing the fuel consumption of motor vehicles with heat engines, the use of systems for putting the engine on stand-by automatically is known, so-called “stop-start” systems, which cut out the engine automatically when the vehicle stops, for example at an intersection, at traffic lights or in a traffic jam. The stop-start system restarts the engine when the driver releases a brake pedal, engages the clutch or presses on an accelerator pedal to set off again, so that engine cut-out takes place transparently for the driver.

For vehicles equipped with such systems there will therefore be a large increase in the number of starting cycles, so that the least economy of power during said starting cycles is reflected in a substantial fuel saving.

Heat engines generally comprise a crankshaft forming a rotor, which is rotated relative to a cylinder block forming a stator.

It has been established that, depending on the relative angular position of the crankshaft and cylinder block when the engine is stopped, restarting requires more or less energy, and the difference in energy required may be up to about 30%.

The use of an electric motor, for example an electric starter of the heat engine, for moving the crankshaft to a position close to the position corresponding to a minimum of power required for starting when the engine is stopped, is known.

In the aforementioned devices, crankshaft repositioning is rapid in order to reach the target position for restarting in a short time, which generates inverse reactions of the engine. In particular, when the pistons are moved quickly they compress the air in the cylinders. This compression leads to oscillations of the crankshaft, in particular around the target position, and this is troublesome during precise positioning of the crankshaft at the target position for restarting the engine.

Now, it is found that the optimum position for restarting is an unstable position for the majority of engines. Departure from this optimum position may therefore be reflected in movement of the crankshaft to a stable position, different from said optimum position (generally the stopped position initially adopted).

Furthermore, the electric motors of starters only have one possible direction of rotation, which means that going past the optimum restarting position requires the execution of an additional complete turn of the crankshaft.

It is therefore necessary to find a method for repositioning the crankshaft that allows quick and accurate return to the optimum position for restarting in a repeatable manner.

To solve the aforementioned problem at least partially, the invention relates to a method for rotational positioning of a heat engine rotor that is in a stopped position to a target position, comprising the following steps:
a device for detecting the angular position of the rotor determines an angular difference from the target position,
a speed set-point as a function of the angular position of the rotor is established on the basis of the angular difference, with a rising slope less than a predetermined value followed until a high speed value is reached less than a predetermined value, and a falling slope less than a predetermined value,
the rotor is moved following the speed set-point.

The method thus executed allows quick and efficient repositioning of the rotor of the heat engine.

Said method may have one or more of the following features, used alone or in combination.

The predetermined values of high speed, of rising slope, and of falling slope are stored in an electronic memory of a control unit.

The predetermined values of high speed, of rising slope, and of falling slope are determined as a function of the moment of inertia of the rotor to limit the torque exerted on said rotor to values below a predetermined torque value.

The engine is a car engine and the predetermined torque value is less than or equal to 20 Nm.

The engine is an engine of a heavy goods vehicle, or of civil-engineering or agricultural machinery, and the predetermined torque value is less than or equal to 40 Nm.

It comprises an additional braking step by short-circuiting the electric motor triggered at a predetermined angular distance calculated as a function of the moment of inertia of the rotor, the rotary speed of the rotor, the friction acting on the rotor and the dissipative power of the electric motor in short-circuit to allow complete stoppage of the rotor in a position close to the optimum position for restarting.

The invention also relates to the associated device for rotational positioning of a heat engine rotor that is in a stopped position to a target position, comprising:
a device for detecting the angular position of the rotor,
a control unit,
an electric motor controlled by the control unit configured for rotating the rotor, characterized in that the control unit is configured for:
interrogating the device for detecting the angular position of the rotor for determining an angular difference from the target position,
establishing a speed set-point as a function of the angular position from the angular difference, with a rising slope less than a predetermined value followed until a high speed value is reached less than a predetermined value, and a falling slope less than a predetermined value,
controlling the movement of the rotor by the electric motor by following the speed set-point.

Other features and advantages of the invention will become clearer on reading the following description, given as an illustrative, non-limiting example, and the appended drawings, where:

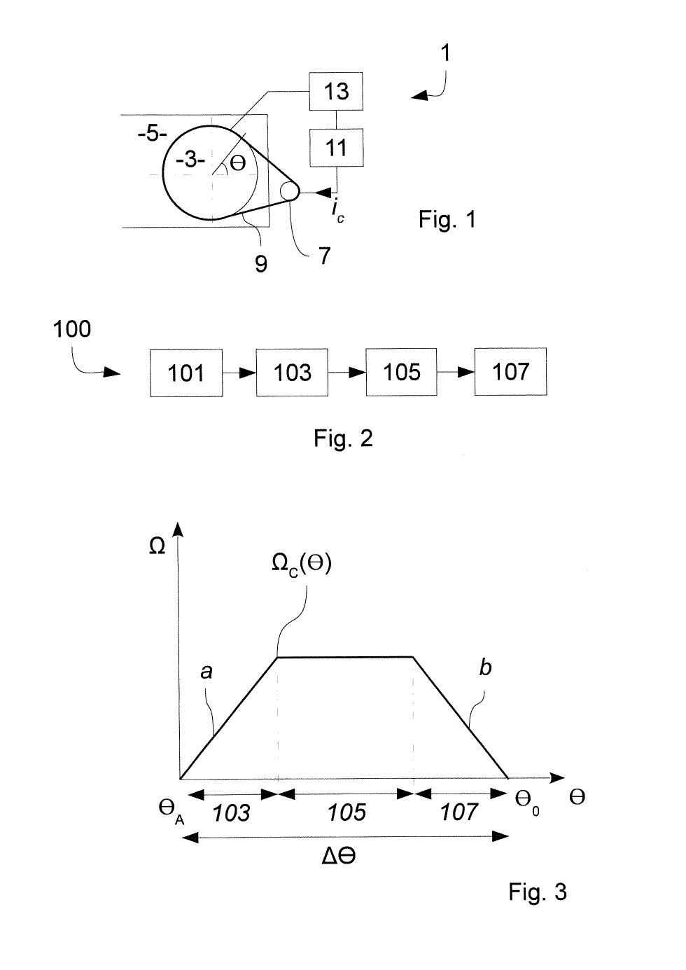

FIG. 1 shows schematically a device for positioning a heat engine rotor according to the invention,

FIG. 2 presents, in the form of a flowchart, the steps of the method for rotor repositioning according to the invention,

FIG. 3 is a graph of the speed set-point as a function of the angular position of the rotor,

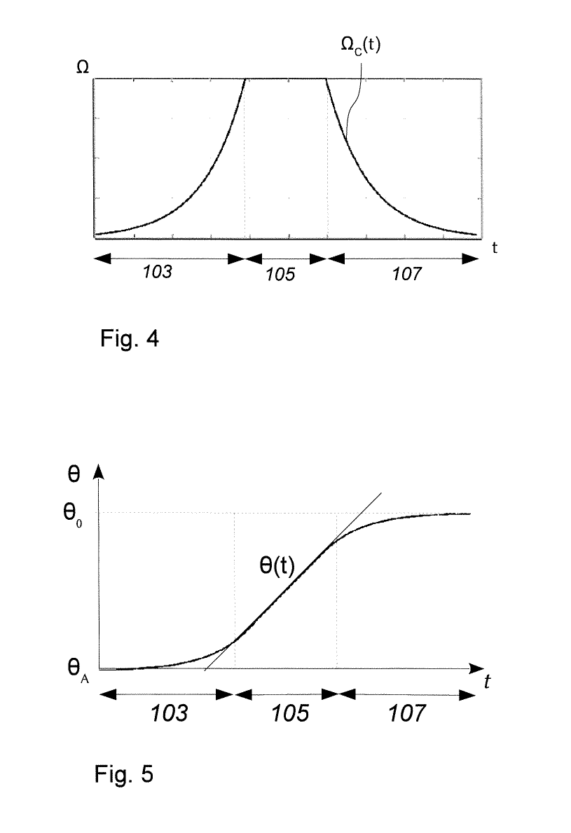

FIG. 4 is a graph of the rotary speed of the rotor over time for a rotor that is rotated following the set-point in FIG. 3,

FIG. 5 is a graph of the angular position of the rotor over time for the rotor in FIG. 4,

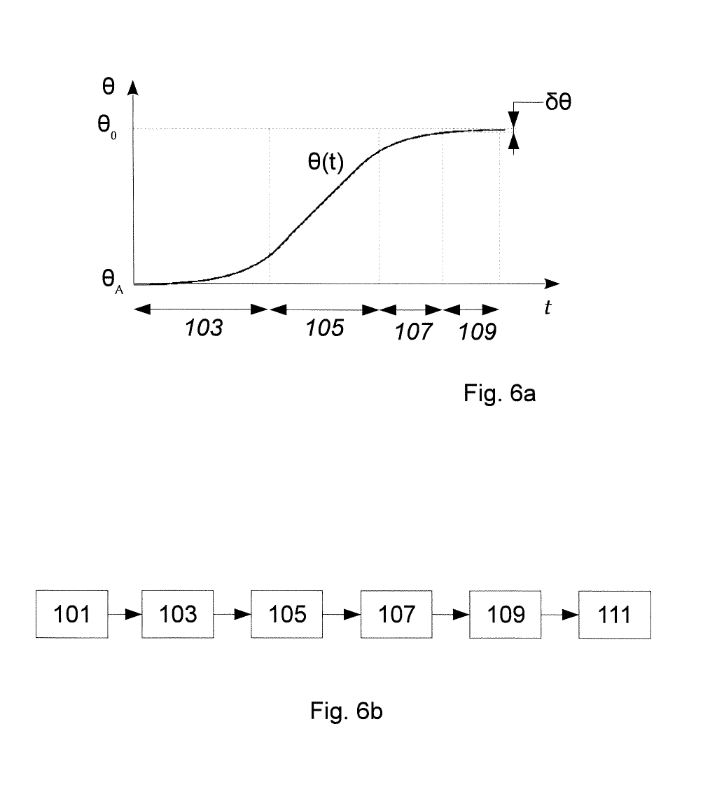

FIG. 6a is a graph of the angular position of the rotor over time in the case of an alternative embodiment of the method of positioning,

FIG. 6b presents, in the form of a flowchart, the steps of the method for rotor repositioning associated with FIG. 6a.

In all the figures, the same references relate to the same elements.

The embodiments described referring to the figures are examples. Although the description refers to one or more embodiments, this does not necessarily mean that each reference relates to the same embodiment, or that the features only apply to a single embodiment. Simple features of different embodiments may also be combined to supply other embodiments.

FIG. 1 shows schematically a positioning device 1 of a heat engine rotor 3. The rotor 3 is rotatable relative to a stator 5 of the heat engine. The rotor 3 may notably be a crankshaft driving one or more pistons of the heat engine. The stator 5 is then the cylinder block in which said crankshaft is mounted.

When the engine is stopped, the rotor 3 is set in motion by an electric motor 7, by means of a drive device 9. In a particular embodiment, said electric motor 7 is a starter or starter-generator of the heat engine, and the drive device 9 comprises a drive belt or a set of gears.

Here, starter-generator means an electric motor that functions as a starter when it is supplied with electric current and as an alternator converting a proportion of the kinetic energy of the rotor 3 into electrical energy for recharging a battery, for example the battery of the vehicle when it is not supplied.

The electric motor 7 is controlled by a set-point current i_{c} supplied by a control unit 11. To enable the position of the rotor 3 to be adjusted, the control unit 11 is connected to a position sensor 13, configured to detect the angular position θ of the rotor 3 relative to the stator 5. Said sensor 13 may comprise detecting means that are electromagnetic, capacitive, optical or with electrical contacts.

In particular, the sensor 13 may comprise Hall-effect analogue sensors and a magnetic target, the Hall-effect sensors being arranged on the stator 5 and the magnetic target on the rotor 3.

FIG. 2 illustrates an example of a method of repositioning associated with the repositioning device 1 of a heat engine rotor 3 according to the invention. FIG. 2 is a flowchart showing the chain of steps leading to the repositioning of the rotor 3 of the heat engine 1.

In a first step 101, the control unit 11 determines the angular difference Δθ between the target position θ₀ and the starting position θ_{A} measured by the position sensor 13. For this purpose, the control unit 11 interrogates the position detector 13 to obtain a value of the angular position θ_{A} at which the heat engine has stopped.

The control unit 11 is connected to or comprises calculating means configured for establishing the difference Δθ between the measured starting position θ_{A} at which the heat engine rotor 3 has stopped and the target position for restarting θ₀. These calculating means typically comprise a processor and one or more electronic memory units, which are either dedicated, or integrated in a global electronic network of the vehicle.

The following steps 103, 105 and 107 are discussed here with reference to FIGS. 3, 4 and 5.

FIG. 3 is a graph showing the rotary speed set-point Ω_{c}(θ) of the rotor 3 according to its angular position θ. The abscissa extends from a starting position θ_{A} to a target position θ₀. The starting position θ_{A} corresponds to the position in which the rotor 3 stopped when the heat engine stopped, for example at an intersection. The target position θ₀ corresponds to the position in which restarting requires the least energy.

The angular domain Δθ between the stop position θ_{A} and the target position θ₀ is divided into three parts corresponding to the next three steps 103, 105, 107 of the method 100.

The method associated with the device 1 as described above is initiated when the heat engine stops, for example at an intersection for an engine equipped with a “stop-start” system.

The rotary speed set-point Ω_{c}(θ) of the rotor 3 of the heat engine is of trapezoidal shape, with a rising slope corresponding to the second step 103, a speed plateau at a high value Ω₀ corresponding to the third step 105, and a falling slope corresponding to the fourth step 107. The high value Ω₀ of speed may notably be stored in an electronic memory of the control unit 11. In particular, the memory of the control unit 11 may contain a maximum value of high speed Ω₀ that is not to be exceeded, the value used in the set-point Ω_{c}(θ) being adjusted as a function of the measured angular difference Δθ and of a target time for execution of the method 100.

The second step 103 corresponds to a phase of acceleration of the rotor 3, according to a predetermined rising slope a, in this case fixed. The rising slope is limited in absolute value to avoid exerting an excessive torque on the rotor 3 by the electric motor 7. In particular, the slope a remains low enough for the torque exerted to stay below 20 Nm for an engine of small or usual size, typically for a car, and below 30 to 40 Nm for engines of larger vehicles (bus, lorry, agricultural or civil-engineering machinery, boat).

Limitation of the slope a thus allows the engine to evacuate the air contained in the cylinders owing to the gradual nature of the acceleration. The resultant limitation of the accelerator torque exerted additionally reduces the noise and vibrations of the engine and of the device 1. As a result, the method 100 may then be executed without the user feeling vibrations or hearing noise which would then be perceived as parasitic since the heat engine is switched off.

In the third step 105, the speed is kept constant, in particular less than or equal to a high value Ω₀. Limitation in terms of maximum speed to the value Ω₀ again allows the heat engine to evacuate the air contained in the cylinders during return of the pistons to top dead centre.

In the fourth step 107, the rotor 3 is slowed down, once again gradually, with a falling slope less than or equal in absolute value to a predetermined value b. Limitation in absolute value of the falling slope b corresponds to a limitation of the braking torque, once again making it possible to limit noise and vibrations.

During its motion the rotor 3 is subject to solid friction, due to friction with the stator 5. When the electric motor 7 is cut out, the rotor 3 continues to turn owing to its moment of inertia, but its movement is braked and then stopped by said friction.

The values of rising slope a and falling slope b are determined for a given heat engine taking into account the moment of inertia of the rotor 3 to limit the torque to be exerted on said rotor 3. Maximum values of slope a and b may in particular be stored in an electronic memory of the control unit 11, the value used in the method 100 being adjusted as a function of a target execution time and the measured angular difference Δθ.

The rotor 3 is set in rotation by actuation of the electric motor 7. The control unit 11 then modulates the supply current i_{c} with optional feedback taking into account the measurement of the position θ in real time obtained by the position sensor 13 of the rotor 3.

For accurate stopping in the optimum position for restarting θ₀, the speed set-point Ω_{c}(θ) is established taking into account the moment of inertia of the rotor 3, and the value of the torque generated by the solid friction. FIG. 4 shows the speed over time that results from monitoring the speed set-point Ω_{c}(θ) of FIG. 3.

The curve of speed as a function of time Ω(t) may be divided into three portions that correspond to the three steps 103, 105, 107 of acceleration, of speed plateau at the value Ω₀ and of deceleration.

In the acceleration step 103, the speed Ω(t) increases according to a rising parabola. In the speed plateau step 105, the speed Ω(t) is constant and has the value Ω₀. In the deceleration step 107, the speed Ω(t) decreases according to a falling parabola.

The rising and falling parabolas of steps 103, 107 of acceleration and of deceleration result from the change of variable between the angular position θ and the time t on the rectilinear rising and falling slopes in FIG. 3.

FIG. 5 is a graph of the angular position θ as a function of time t, illustrating the positioning kinematics in the ideal restarting position θ₀ of the rotor 3.

The time interval shown in FIG. 5 may once again be divided into three intervals corresponding to the aforementioned steps 103, 105, 107.

In the first interval corresponding to the acceleration step 103, the angular position θ gradually increases, which corresponds to gradual acceleration at the start of the method 100.

In the second interval, the angular position θ increases linearly, with Ω₀ as the direction parameter. In the constant speed step 105 this interval corresponds to the value Ω₀.

In the third interval corresponding to the deceleration step 107, the angular position θ increases more and more slowly and stabilizes at the value θ₀ corresponding to the required target position.

An alternative embodiment of method 100 is illustrated in FIGS. 6a and 6b. FIG. 6a is a graph of the angular position θ of the rotor 3 over time t, in which the time domain shown is subdivided into four intervals corresponding to four steps 103 to 109, the first three of which correspond to the steps of acceleration 103, of speed plateau 105 and of deceleration 107 as described above. A fifth step 111 at constant angular position θ is also provided. FIG. 6b presents, in the form of a flowchart, the steps 101 to 111 associated with the graph in FIG. 6a.

The embodiment in FIGS. 6a, 6b further comprises an additional braking step 109, during which the electric motor 7, which in the majority of vehicles is a synchronous DC motor supplied from the vehicle's battery, is short-circuited.

During this step 109, short-circuiting of the electric motor 7 generates a braking torque by dissipation of magnetic flux. Short-circuiting is in particular triggered when the rotor 3 is at a predetermined angular distance δθ from the optimum position for restarting θ₀.

The predetermined angular distance δθ is in particular calculated as a function of the moment of inertia of the rotor 3, of its speed, of the friction to which it is subjected and the dissipative power of the electric motor 7 in short-circuit to allow complete stoppage in a position as close as possible to the optimum position for restarting θ₀.

The next step 111 is a step of maintaining the short-circuit, for at least some hundredths to some tenths of a second, during which the control unit 11 verifies in particular that the angular position θ remains constant. This maintaining of the short-circuit, and therefore of the rotational braking, makes it possible to ensure that no reaction, possibly delayed, of the pistons or of the engine 1 alters the final position of the rotor 3, near the target position θ₀.

A delayed reaction of this kind may notably result from the air escaping from the cylinders at a low flow rate. Maintaining the braking 111 also allows the forces of static friction, which are higher than the forces of dynamic friction, to come into effect.

The fact that the electric motor 7 is maintained in short-circuit also makes it possible to increase the energy required for the rotor 3 to travel through an angular opening in question. The rotor 3 is thus less likely to overshoot the optimum restarting position θ₀ and then adopt a more stable position spontaneously (top dead centre or bottom dead centre of the pistons). This avoids a large overshoot of the target position θ₀ by the rotor 3, making it possible to use electric motors 7 with a single sense of rotation, as implemented in most starters and starter-generators.

The speed set-point Ω_{c}(θ) may in particular be calculated additionally taking into account the pulley ratio between the electric motor 7 and the heat engine and the tensioning of the belt or pulley of the drive device 9.

The method according to the invention therefore allows accurate and repeatable positioning of the rotor 3 of a heat engine in a position θ₀ allowing restarting of the heat engine with less energy. Moreover, the method according to the invention essentially uses devices that are already present in most vehicles (position sensor 13 of the rotor 3, starter-generator as electric motor 7) and may therefore easily be implemented in the majority of vehicles.

1. A method for rotational positioning of a heat engine rotor that is in a stopped position to a target position, comprising:
determining, by a device for detecting the angular position of the rotor, determines an angular difference from the target position;
establishing a speed set-point as a function of the angular position of the rotor is established on the basis of the angular difference, with a rising slope less than a predetermined value followed until a high speed value is reached less than a predetermined value, and a falling slope less than a predetermined value; and
setting the rotor is set in motion following the speed set-point.

2. The method of positioning according to claim 1, wherein the predetermined values of high speed, of rising slope, and of falling slope are stored in an electronic memory of a control unit.

3. The method of positioning according to claim 1, wherein the predetermined values of high speed, of rising slope, and of falling slope are determined as a function of the moment of inertia of the rotor to limit the torque exerted on said rotor to values below a predetermined torque value.

4. The method of positioning according to claim 3, wherein the engine is a car engine and in that the predetermined torque value is less than or equal to 20 Nm.

5. The method of positioning according to claim 3, wherein the engine is an engine of a heavy goods vehicle, or else of civil-engineering or agricultural machinery, and in that the predetermined torque value is less than or equal to 40 Nm.

6. The method of positioning according to claim 1, further comprising an additional braking step by short-circuiting the electric motor triggered at a predetermined angular distance calculated as a function of the moment of inertia of the rotor, the rotary speed of the rotor, the friction acting on the rotor and the dissipative power of the electric motor in short-circuit to allow complete stoppage of the rotor in a position close to the optimum position for restarting.

7. A device for rotational positioning of a heat engine rotor that is in a stopped position in a target position, comprising:
a device for detecting the angular position of the rotor;
a control unit;
an electric motor controlled by the control unit configured for rotating the rotor,
wherein the control unit is configured for:
interrogating the device for detecting the angular position of the rotor to determine an angular difference from the target position,
establishing a speed set-point as a function of the angular position from the angular difference, with a rising slope less than a predetermined value followed until a high speed value is reached less than a predetermined value, and a falling slope less than a predetermined value,
monitoring the setting in motion of the rotor by the electric motor by following the speed set-point.
